(19) United States
(12) Patent Application Publication
(10) Pub. No.: US 2025/0187741 A1
(43) Pub. Date: Jun. 12, 2025

(54) METHOD FOR ASSISTING THE PILOTING OF A ROTORCRAFT AND ROTORCRAFT THUS EQUIPPED

(71) Applicant: AIRBUS HELICOPTERS, Marignane Cedex (FR)

(72) Inventor: Stéphane CERQUEIRA, Eguilles (FR)

(73) Assignee: AIRBUS HELICOPTERS, Marignane Cedex (FR)

(21) Appl. No.: 18/636,620

(22) Filed: Apr. 16, 2024

(30) Foreign Application Priority Data
Jul. 21, 2023 (FR) 2307870

(51) Int. Cl. B64D 31/09

(52) U.S. Cl. CPC B64D 31/09

(57) ABSTRACT

A method for assisting the piloting of a rotorcraft comprising a first engine and a second engine, each capable, in the absence of a failure, of transmitting engine torque to at least one rotor providing at least lift keeping the rotorcraft in the air. The rotorcraft has aerodynamic members for piloting the rotorcraft. The method has these steps: controlling the first engine and the second engine asymmetrically, the first engine alone providing driving power to the rotor(s), the second engine operating at a standby speed; identifying an engine failure in the first engine by a failure monitor; and in the event of failure in the first engine, accelerating the second engine to a synchronization speed.

### CROSS REFERENCE TO RELATED APPLICATIONS

This application claims the benefit of FR 23 07870 filed on Jul. 21, 2023, the disclosure of which is incorporated in its entirety by reference herein.

### TECHNICAL FIELD

The present disclosure relates to a method for assisting the piloting of a rotorcraft, an assistance system and a rotorcraft thus equipped.

### BACKGROUND

Such a rotorcraft is provided with a power unit comprising at least two engines and at least one lift rotor rotated by the power unit.

Moreover, the operation of the engines is managed by a control system. This control system makes it possible to implement an engine operating mode commonly referred to as the “All Engines Operating” or AEO mode wherein all of the engines of the power unit are operational and each transmits driving power to the power-consuming components of the rotorcraft such as the rotor or rotors.

In order to reduce the fuel consumption of the aircraft heat engines, an operating mode referred to as an “economy” operating mode may be used, principally during a cruising flight phase. In this economy operating mode, a single heat engine supplies the power required to rotate the rotor or rotors of the aircraft. The other heat engine or engines do not supply significant mechanical power, or indeed do not supply any power.

According to a first variant, a single heat engine operates and rotates the rotor of the rotorcraft on its own. The other heat engine or engines are stopped and are not supplied with fuel. However, in a free turbine turboshaft engine, the rotating members of the gas generator can be kept rotating by an electric motor in order to facilitate and accelerate the restarting of the engine.

According to a second variant, all of the engines are started and supplied with fuel, but only one heat engine supplies significant mechanical power to rotate the rotor or rotors of the rotorcraft. The other heat engine or heat engines are started, but only operate in a “super-slow” mode and therefore do not supply any mechanical power.

Irrespective of the variant of this economy operating mode, the operation of the heat engines is therefore asymmetrical, as the heat engines do not operate in an identical manner.

Therefore, document EP3738888 discloses a method for operating a rotorcraft comprising a plurality of engines designed to supply driving power to at least one rotor.

Moreover, an asymmetrical operating mode is implemented wherein at least one first engine is referred to as an “active” engine, i.e.,, it supplies driving power to at least one rotor, and at least one second engine is referred to as an “inactive” engine, i.e., it supplies substantially no driving power.

This method comprises monitoring for a failure of the active engine. In the event of such a failure, the power output by the inactive engine is automatically increased. The reactivated inactive engine then operates in a “One Engine Inoperative” or OEI mode. An available engine operating in OEI mode supplies sufficient power until landing, in order to allow the rotorcraft to continue flying temporarily even though one of the engines is unavailable.

During the transitional phase between the failure of the active engine and the reactivation of the inactive engine, the mechanical power transmitted to the rotor or rotors is therefore temporarily zero or greatly reduced.

Document EP 3 693 582 discloses methods and systems for operating an aircraft provided with at least two engines. The method consists in operating the engines in an asymmetrical operating mode.

Document US 2022/025941 describes a fail-safe multi-mode clutch assembly positioned in a powertrain of a rotorcraft. This assembly comprises a free-wheel.

Document EP 3 951 150 relates to a method for controlling an aircraft comprising a first engine, a second engine, at least one rotor and a transmission interposed between the rotor and the first and second engines.

The transmission comprises a first input and a second input linked respectively to a first output member of the first engine and to a second output member of the second engine.

Document U.S. Pat. No. 4 817 046 describes a method for detecting engine failure in a multi-engine aircraft. Such a detection is based on thresholds being crossed, in particular with respect to engine torque (Q), the speed of the gas generator (NG), the temperature of the internal stage of the power turbine (T5) and the speed of the power turbine (NF).

### SUMMARY

An object of the present disclosure is thus to propose an assistance method and system to help reduce the workload of the pilot or pilots during the transitional phase.

Therefore, one aim of the disclosure is to assist pilots and allow them to perform other tasks during this transitional phase, in particular during a flight in conditions of low visibility.

The disclosure therefore relates to a method for assisting the piloting of a rotorcraft comprising a first engine and a second engine each capable, in the absence of a failure, of transmitting engine torque to at least one rotor providing at least lift keeping the rotorcraft in the air, the rotorcraft comprising aerodynamic members for piloting the rotorcraft, the assistance method comprising the following steps:
controlling the first engine and the second engine asymmetrically, the first engine alone providing driving power to said at least one rotor, the second engine operating at a standby speed wherein the second engine does not provide any driving power to said at least one rotor;
identifying an engine failure in the first engine by means of a failure monitor; and
in the event of a said engine failure in the first engine, accelerating the second engine from the standby speed to a synchronization speed wherein the second engine alone transmits the driving power to said at least one rotor.

This method is remarkable in that, after identifying the engine failure in the first engine and as long as the operating speed of the second engine is less than a synchronization speed, the assistance method comprises the following steps performed several times or repeatedly:
periodically detecting, during flight, current values of at least two state parameters by means of at least two separate sensing devices, said at least two state parameters being of different natures and comprising a first state parameter representative of a physico-chemical environmental condition or a position of the rotorcraft in relation to an external environment and a second state parameter representative of the operation of the rotorcraft; and
periodically generating, with an autopilot controller, control orders for controlling actuators linked to the aerodynamic members during an automatically piloted autorotation flight phase, the periodic generation implementing a predetermined control law that is a function of said at least two state parameters, the predetermined control law being specifically applicable to the assistance method.

In other words, such an assistance method allows a rotorcraft to be piloted automatically during an autorotation flight phase following the failure of the active engine during an asymmetrical flight. Furthermore, such a rotorcraft may comprise one or more initially active first engines and one or more initially inactive second engines. However, for the sake of clarity and simplification, the rotorcraft is described in a non-exhaustive manner as having a first engine and a second engine.

Therefore, the periodic generation of the control orders is implemented automatically as soon as the failure monitor detects an engine failure in the first engine that renders it inoperative.

Such an autorotation flight phase ends when the initially inactive second engine becomes active and thus transmits the necessary engine torque to said at least one rotor.

The pilot can then pilot the rotorcraft by operating the control members in order to control the actuators linked to the aerodynamic members. The pilot can thus continue the flight with only the second engine that has become active or can decide to land.

The control law that is used to generate the control orders during the periodic generation may advantageously be predetermined by trials, flight tests and/or simulations. This control law may, for example, consist of a computer algorithm, artificial intelligence, a mathematical formula, a table of values or a chart. The control law may use the current values of at least two state parameters so as to automatically generate the control orders without the pilot or pilots needing to take any particular action, thus allowing them to concentrate on other actions such as monitoring the terrain, detecting obstacles, restarting and synchronizing the second engine and a gearbox, etc.

Furthermore, the values of the state parameters may be periodically evaluated during flight, at a predetermined detection frequency, by sensing devices comprising dedicated sensors or sensors shared with other systems of the rotorcraft.

The failure monitor and the autopilot controller may each comprise, for example, at least one processor and at least one memory, at least one integrated circuit, at least one programmable system, or at least one logic circuit, these examples not limiting the scope to be given to the term “controller”. The term “processor” may refer equally to a central processing unit or CPU, a graphics processing unit or GPU, a digital signal processor or DSP, a microcontroller, etc. The failure monitor and the autopilot controller may form one and the same controller.

Furthermore, the synchronization speed of the second engine may be defined by a rotational speed differential between two shafts linked by a free-wheel. Such a free-wheel enables the second engine(s) to rotate a power transmission drive train. An engine torque can thus be transmitted from an output shaft of the second engine to an input shaft of a main gearbox.

Alternatively, as long as the output shaft of the second engine rotates at a lower speed than the input shaft of the main gearbox, the free-wheel does not enable this second engine to transmit engine torque to the drive train and therefore to the rotor(s).

Furthermore, the first and second engines may be combustion engines and the acceleration of the second engine from the standby speed to a synchronization speed may be achieved, for example, by increasing a flow rate of fuel supplying the second engine. A fuel metering valve is then controlled by a controller as a function of the rotational speed of the output shaft of the second engine and that of the input shaft of the main gearbox.

In practice, the first state parameter may be chosen from the group comprising air temperature, atmospheric pressure, altitude, air density, the air speed of the rotorcraft relative to the air, the ground speed of the rotorcraft relative to the ground, the vertical acceleration of the rotorcraft relative to the ground and the attitude of the rotorcraft in a terrestrial reference frame.

Therefore, the current values of this first state parameter, when it is representative of a physico-chemical environmental condition, can be linked to the air located in the vicinity of the rotorcraft and/or to the movement of the rotorcraft relative to the air. In other words, the physico-chemical environmental condition may therefore be the outside air temperature, the atmospheric pressure of the outside air, the outside air density, the air speed of the rotorcraft relative to the outside air.

Alternatively, the current values of this first state parameter, when it is representative of a position of the rotorcraft in relation to an external environment, can be linked to the position or movement of the rotorcraft relative to the ground. In other words, the position of the rotorcraft in relation to an external environment may therefore be the altitude of the rotorcraft relative to sea level, the ground speed of the rotorcraft relative to the ground, the vertical acceleration of the rotorcraft relative to the ground and the attitude of the rotorcraft in a terrestrial reference frame.

Furthermore, the second state parameter may be chosen from the group comprising the rotational speed NR of said at least one rotor, the power transmitted by the second engine to said at least one rotor, the engine torque transmitted by the second engine to said at least one rotor, the rotational speed of a gas generator N1 of the second engine, the rotational speed N2 of a free turbine of the second engine, the temperature TET of the gases at the inlet of a high-pressure turbine of a gas generator of the second engine and the temperature T45 of the gases at the inlet of a free turbine of the second engine.

The current values of this second state parameter are therefore linked to the operation of an internal component of the rotorcraft and are therefore different in nature to the first state parameter.

Advantageously, the first state parameter may be the air speed of the rotorcraft relative to the air and the second state parameter may be the rotational speed NR of said at least one rotor.

Such a combination of the first and second state parameters enables the control law to generate control orders that guarantee that the rotorcraft can carry out an autorotation flight phase safely.

According to one embodiment of the disclosure, the aerodynamic members may comprise blades of said at least one rotor, the actuators controlling at least the pitch of the blades.

Therefore, the assistance method allows the pitch of the blades of the rotor or rotors to be controlled. In particular, the actuators can act directly or via a drive train on the pitch-change plates and the pitch rods linked to the blades.

In practice, the control orders can be transmitted to the actuators to generate a collective and identical reduction in blade pitch and/or a cyclic change in blade pitch.

Such a collective reduction in blade pitch makes it possible, in particular, to keep the rotational speed of the rotor constant or increase it, and the cyclic change in blade pitch allows the trajectory of descent of the rotorcraft to be controlled and stabilized.

Furthermore, the assistance method may comprise displaying, on a display, at least an item of information chosen from the group comprising the current values of said at least two state parameters and an item of information representative of the transmission of the control orders from the autopilot controller to the actuators.

Such a display operation also allows the pilot to follow the actions performed by the autopilot controller and the actuators. This display may, for example, comprise a screen for displaying dials, each with a movable pointer or scales, each with a movable index forming information carrying the current values of said at least two state parameters.

An object of the present disclosure is also a computer program comprising instructions that, when the program is run, cause the assistance method described above to be implemented.

The program is, for example, run by a computing device or a computer comprising at least one processor, at least one integrated circuit, at least one programmable system, at least one logic circuit, and a memory, these examples not limiting the scope given to the expression “computing device” or “computer”.

The memory is used to store the computer program and various information used by the computer program, i.e., the control setpoints to be transmitted to said actuators, the current values of said at least two state parameters and the predetermined control law to be implemented.

The disclosure also relates to a rotorcraft comprising a first engine and a second engine each capable, in the absence of a failure, of transmitting engine torque to at least one rotor providing at least lift keeping the rotorcraft in the air.

According to the disclosure, such a rotorcraft is remarkable in that it comprises a system for assisting the piloting of the rotorcraft configured to implement the abovementioned assistance method, the system comprising the failure monitor, the autopilot controller, the actuators and said at least two sensing devices.

Such a system is integrated into a rotorcraft and as such constitutes equipment of the rotorcraft. The piloting assistance system can thus be connected to a flight management device of the rotorcraft. The autopilot controller can also be dedicated to the piloting assistance system or be shared with an automatic flight control device of the rotorcraft used conventionally during a flight of the rotorcraft and in the absence of an engine failure.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a schematic diagram of a rotorcraft provided with an assistance system for implementing the assistance method according to the disclosure; and

FIG. 2 is a logic diagram showing the steps of an assistance method according to the disclosure.

### DETAILED DESCRIPTION

Elements that are present in more than one of the figures are given the same references in each of them.

As already mentioned, the disclosure relates to a method for assisting the piloting of a rotorcraft.

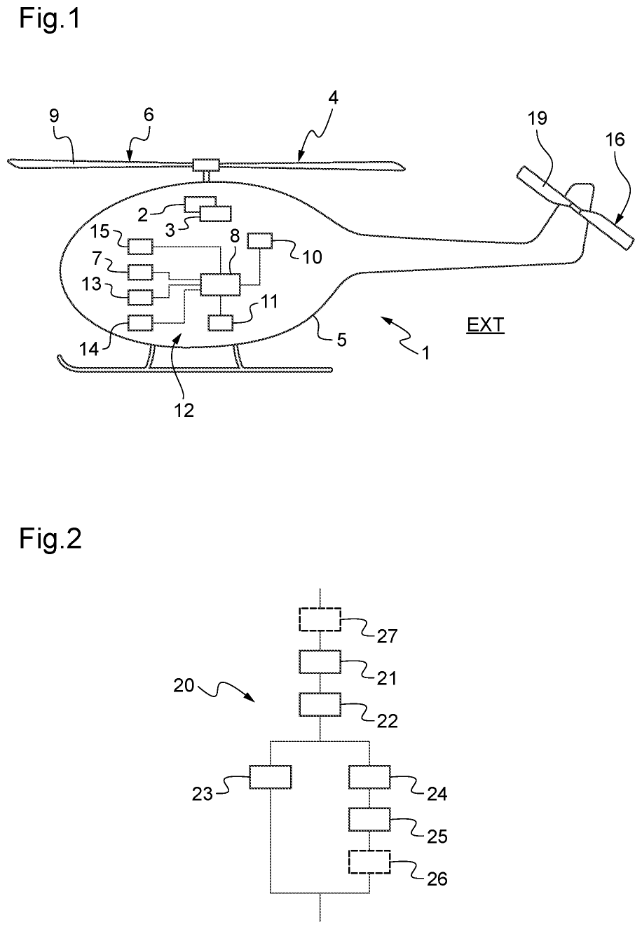

As shown in FIG. 1, such a rotorcraft 1 has at least two engines, including a first engine 2 and a second engine 3 each capable, in the absence of a failure, of transmitting engine torque to at least one main rotor 4 providing at least lift keeping the rotorcraft 1 in the air. The engines 2, 3 are therefore connected to a power transmission drive train leading to at least one main rotor 4.

The rotorcraft 1 also comprises aerodynamic members 6 used to control the rotorcraft 1 in the air. These aerodynamic members 6 may comprise at least one blade 9 of the main rotor or rotors 4, at least one blade 19 of a rear rotor 16, and/or movable flaps arranged, for example, on an empennage, on a vertical stabilizer, on the blades 9 of the main rotor or rotors 4, on the blades 19 of the rear rotor 16 or indeed on a wing of the rotorcraft 1.

Such movable flaps may therefore be used to modify the overall lift generated by the aerodynamic members 6 and/or to help control the movements of the rotorcraft 1, in particular during an autorotation flight phase of the rotorcraft 1.

Furthermore, such a rotorcraft 1 also comprises actuators 10 comprising, for example, servocontrols and/or jacks used to directly or indirectly move the aerodynamic members 6. For example, jacks in series and in parallel move a mechanical channel controlling a servocontrol engaged on a set of swashplates linked to blades 9 by pitch rods.

These actuators 10 may therefore receive control orders generated by an autopilot controller 8. The autopilot controller 8 may comprise, for example, a control unit of an automatic flight control system known by the acronym AFCS.

Moreover, such a rotorcraft 1 also comprises at least two sensing devices 13, 14 separate from each other, these sensing devices 13, 14 issuing analog or digital signals to the autopilot controller 8 via wired or wireless means.

The sensing device or devices 13 make it possible to detect, during flight, current values of a first state parameter representative of a physico-chemical environmental condition of the rotorcraft 1 or a position of the rotorcraft 1 in relation to an external environment EXT. The sensing device or devices 13 may in particular have sensors sensing the position, speed or acceleration of the rotorcraft 1, an inertial unit or an anemobarometric system.

Furthermore, the first state parameter may be chosen from the group comprising air temperature, atmospheric pressure, altitude, air density, the air speed of the rotorcraft 1 relative to the air, the ground speed of the rotorcraft 1 relative to the ground, the vertical acceleration of the rotorcraft 1 relative to the ground and the attitude of the rotorcraft 1 in a terrestrial reference frame.

The sensing device or devices 13 may therefore comprise a thermometer measuring the air temperature, a barometer measuring the atmospheric pressure outside the rotorcraft 1 and an altimeter measuring the altitude of the rotorcraft 1.

The density of the air can be estimated using the air temperature and atmospheric pressure values.

The anemobarometric system may be used to measure the air speed of the rotorcraft 1 relative to the air, and the altitude.

The sensing device or devices 14 may be used to detect, during flight, current values of a second state parameter representative of the operation of the rotorcraft 1.

The second state parameter may be chosen from the group comprising the rotational speed NR of said at least one rotor 4, the power transmitted by the second engine 3 to said at least one rotor 4 via the drive train, the engine torque transmitted by the second engine 3 to said at least one rotor 4 via the drive train, the rotational speed of a gas generator N1 of the second engine 3, the rotational speed N2 of a free turbine of the second engine 3, the temperature TET of the gases at the inlet of a high-pressure turbine of a gas generator of said second engine 3 and the temperature T45 of the gases at the inlet of a free turbine of the second engine 3.

The sensing device or devices 14 may in particular have position, speed or acceleration sensors for measuring or determining the rotational speed NR, position, speed for acceleration sensors for measuring or determining the rotational speed of the gas generator N1 of the second engine 3, position, speed or acceleration sensors for measuring or determining the rotational speed N2 of a free turbine of the second engine 3 or indeed an output shaft of the second engine 3, and a torquemeter measuring the torque transmitted by the output shaft of the second engine 3 to said at least one rotor 4.

The sensing device or devices 14 may also have temperature sensors such as thermometers measuring the temperature TET of the gases at the inlet of a high-pressure turbine of a gas generator of the second engine 3 and the temperature T45 of the gases at the inlet of a free turbine of the second engine 3.

“Sensors” should in this case be understood to mean physical sensors capable of directly measuring the parameter in question but also a system that may comprise one or more physical sensors as well as means for processing the signal that make it possible to provide an estimation of the parameter based on the measurements provided by this or these physical sensors. Similarly, the current value or measurement of this this parameter refers to both a raw measurement from a physical sensor and a value obtained by processing a signal from this raw measurement.

Moreover, said at least two sensing devices 13, 14 can be used to measure and transmit, to the autopilot controller 8, data that varies as a function of the control orders transmitted to the actuators 10. This data can be used to implement a control loop designed, for example, to ensure an autorotation flight phase using the predetermined control law.

Furthermore, the rotorcraft 1 may comprise at least one mission system 15 connected via wired or wireless means to the autopilot controller 8 and possibly to said at least two sensing devices 13, 14. Such a mission system 15 is configured to set the parameters of the autopilot controller 8 and possibly said at least two sensing devices 13, 14 depending on flight constraints related to the mission that is to be performed by the rotorcraft 1 or piloting preferences.

This mission system 15 may in particular comprise a human-machine interface that enable the pilot to input piloting preferences relating to an autorotation flight phase. Such preferences may, for example, make it possible to adapt or replace the predetermined control law with another predetermined control law.

Furthermore, the rotorcraft 1 may comprise a display 11 connected via wired or wireless means to the autopilot controller 8 and possibly to said at least two sensing devices 13, 14.

Such a display 11 may, in particular, be used to display information visible to a pilot, for example the current values of said at least two state parameters and/or information representative of the transmission of the control orders from the autopilot controller 8 to the actuators 10. Therefore, the pilot may in particular be informed that the autopilot controller 8 is active and is controlling the rotorcraft 1 to perform an autorotation flight phase.

Moreover, in the event of failure of the first engine 2, a method 20 for assisting the piloting of the rotorcraft 1 as shown in FIG. 2 can be implemented.

Such an assistance method 20 therefore comprises a plurality of steps and, in particular, a step of controlling 21 the first engine 2 and the second engine 3 asymmetrically, implemented by the AFCS, for example. Such a control step 21 can therefore be used to control fuel metering valves of the engines 2,3 so that the first engine 2 alone provides driving power to said at least one rotor 4 and so that the second engine 3 operates at a standby speed wherein this second engine 3 does not provide any driving power to said at least one rotor 4.

The assistance method 20 then comprises identifying 22 an engine failure in the first engine 2 by means of a failure monitor 7 that is possibly connected to at least one sensing device having a position, speed or acceleration sensor or a temperature sensor configured to measure a parameter linked to the operation of the first engine 2.

Such a failure monitor 7 is therefore a conventional controller capable of performing conventional control operations and, in particular, of comparing the current value generated by a sensor with a threshold value, and then possibly issuing an alarm signal if this threshold value, that may, for example, be a minimum engine torque, is crossed.

The assistance method 20 then comprises an acceleration 23 implemented, for example, by the AFCS, to increase the operating speed of the second engine 3 from the standby speed to a synchronization speed wherein this second engine 3 alone provides driving power to said at least one rotor 4.

Such an acceleration 23 may be implemented by the AFCS controlling at least one fuel metering valve of the second engine 3 so that its speed increases and shifts from the standby speed to the synchronization speed. Once this synchronization speed is reached, the AFCS can control the fuel metering valve to keep the operating speed of the second engine 3 constant or increase it.

In parallel with this acceleration 23, as soon as a failure has been identified in the first engine and as long as the operating speed of the second engine 3 is less than the synchronization speed, the assistance method 20 comprises a step of periodically detecting 24, during flight, current values of at least two state parameters with the sensing devices 13, 14.

The sensing devices 13, 14 are connected to the autopilot controller 8 via wired or wireless means and thus each transmit analog, digital, electrical or optical signals carrying respective current values of the at least two state parameters. The periodic detection 24 makes it possible to detect and transmit these current values of the at least two state parameters at a first predetermined time interval.

The assistance method 20 comprises periodically generating 25 control orders with the autopilot controller 8 to control the actuators 10 linked to the aerodynamic members 6 and pilot the rotorcraft 1 according to an autorotation flight phase.

Such a periodic generation 25 of the control orders is therefore also carried out at a second predetermined time interval depending on the variations in the at least two state parameters.

The first and second time intervals may possibly be equal.

Moreover, such a periodic generation 25 is implemented by the autopilot controller 8, that determines the control orders by applying a control law stored in a memory that may be independent or comprised in the autopilot controller 8, said control law being a function of the at least two state parameters for generating the control orders.

Advantageously, the assistance method 20 may also comprise displaying 26, on the display 11, the current values of said at least two state parameters and/or information representative of the transmission of the control orders from the autopilot controller 8 to the actuators 10.

Such a display 11 is thus connected to the autopilot controller 8 via wired or wireless means and receives analog, digital, electrical or optical signals carrying the current values of the at least two state parameters and/or the transmission of the control orders from the autopilot controller 8 to the actuators 10 when said periodic generation 25 of the control orders is implemented.

Similarly, such an assistance method 20 may possibly comprise a preliminary step of determining 27 a type of mission or preferences. Such a step of determining 27 a type of mission may, for example, be implemented by means of the mission system 15, that then transmits a signal representative of the type of mission or preferences to the autopilot controller 8.

Once this determination step 27 has been implemented, the rotorcraft 1 can then take off and carry out or begin its mission.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A method for assisting the piloting of a rotorcraft comprising a first engine and a second engine each capable, in the absence of a failure, of transmitting engine torque to at least one rotor providing at least lift keeping the rotorcraft in the air, the rotorcraft comprising aerodynamic members for piloting the rotorcraft, the assistance method comprising the following steps:
controlling the first engine and the second engine asymmetrically, the first engine alone providing driving power to the rotor(s), the second engine operating at a standby speed wherein the second engine does not provide any driving power to the rotor(s);
identifying an engine failure in the first engine by means of a failure monitor; and
in the event of the engine failure in the first engine, accelerating the second engine from the standby speed to a synchronization speed wherein the second engine alone transmits the driving power to the rotor(s),
wherein, after identifying the engine failure in the first engine and as long as an operating speed of the second engine is less than the synchronization speed, the assistance method including the following steps:
periodically detecting, during flight, current values of at least two state parameters by means of at least two separate sensing devices, the at least two state parameters being of different natures and comprising a first state parameter representative of a physico-chemical environmental condition or a position of the rotorcraft in relation to an external environment and a second state parameter representative of the operation of the rotorcraft; and
periodically generating, with an autopilot controller, control orders for controlling actuators linked to the aerodynamic members during an automatically piloted autorotation flight phase, the periodic generation implementing a predetermined control law that is a function of the at least two state parameters, the predetermined control law being specifically applicable to the assistance method.

2. The method according to claim 1,
wherein the first state parameter is chosen from the group consisting of air temperature, atmospheric pressure, altitude, air density, the air speed of the rotorcraft relative to the air, the ground speed of the rotorcraft relative to the ground, the vertical acceleration of the rotorcraft relative to the ground and the attitude of the rotorcraft in a terrestrial reference frame.

3. The method according to claim 1,
wherein the second state parameter is chosen from the group consisting of the rotational speed NR of the rotor(s), the power transmitted by the second engine to the rotor(s), the engine torque transmitted by the second engine to the rotor(s), the rotational speed of a gas generator N1 of the second engine, the rotational speed N2 of a free turbine of the second engine, the temperature TET of the gases at the inlet of a high-pressure turbine of a gas generator of the second engine and the temperature T45 of the gases at the inlet of a free turbine of the second engine.

4. The method according to claim 2,
wherein the second state parameter is chosen from the group consisting of the rotational speed NR of the rotor(s), the power transmitted by the second engine to the rotor(s), the engine torque transmitted by the second engine to the rotor(s), the rotational speed of a gas generator N1 of the second engine, the rotational speed N2 of a free turbine of the second engine, the temperature TET of the gases at the inlet of a high-pressure turbine of a gas generator of the second engine and the temperature T45 of the gases at the inlet of a free turbine of the second engine and wherein the first state parameter is the air speed of the rotorcraft relative to the air and the second state parameter is the rotational speed NR of the rotor(s).

5. The method according to claim 1,
wherein the aerodynamic members comprise blades of the rotor(s), the actuators controlling at least the pitch of the blades.

6. The method according to claim 5,
wherein the control orders are transmitted to the actuators to generate a collective and identical reduction in the pitch of the blades and/or a cyclic change in the pitch of the blades.

7. The method according to claim 1,
wherein the assistance method comprises displaying, on a display, at least one item of information chosen from the group consisting of the current values of the at least two state parameters and an item of information representative of the transmission of the control orders from the autopilot controller to the actuators.

8. A computer program comprising instructions that, when the program is run, cause the assistance method according to claim 1 to be implemented.

9. A rotorcraft comprising a first engine and a second engine each capable, in the absence of a failure, of transmitting engine torque to at least one rotor providing at least lift keeping the rotorcraft in the air,
wherein the rotorcraft comprises a system for assisting the piloting of the rotorcraft configured to implement the assistance method according to claim 1, the system comprising the failure monitor, the autopilot controller, the actuators and the at least two sensing devices.
